(19) United States
(12) Patent Application Publication
(10) Pub. No.: US 2009/0309372 A1
(43) Pub. Date: Dec. 17, 2009

(54) Magnaforce generator

(76) Inventors: Stephen Calanari Sayre, Taft, CA (US); Garrett Stewart Sayre, Yorktown, VA (US)

Correspondence Address: Garrett S. Sayre, 1900 I Piccadilly Loop, Yorktown, VA, 23692, US

(21) Appl. No.: 12/455,982

(22) Filed: Jun. 10, 2009

Related U.S. Application Data
(60) Provisional application No. 61/131,680, filed on Jun. 11, 2008.

(51) Int. Cl. F03G 7/00; H02K 21/00; F03G 7/10

(52) U.S. Cl. 290/1 R; 310/152; 415/916

(57) ABSTRACT

The MagnaForce Generator is an energy producing device using magnetic force in a way that allows continuous movement to produce energy. The device described above where one or more of the magnets are attached to a device which moves the magnet(s) to maximize the free flow of the movement created by the magnetic fields. Most likely magnets in a circle with a spinning magnet on a shaft in the middle The device described incorporates piston(s) which retreats into a cylinder to avoid opposing forces from or related to the primary rotational device that do not complement the production of energy and that emerge to assist in the production. The device incorporates materials that redirect the magnetic fields to maximize the production of energy. The device described might incorporate any pre-existing braking device. The device described might incorporate a pre-existing generating device. The device described might incorporate a locomotive device.

### FIELD OF INVENTION

This invention relates to the production of continuous movement using magnetic force for the production of energy.

### BACKGROUND OF THE INVENTION

The MagnaForce Generator is designed to use magnetic force to produce energy by using a system of directing and redirecting magnetic energy.

### SUMMARY OF INVENTION

The objective of this invention is to produce energy using permanent magnets in a system of directing and redirecting magnetic force.
The objective of this device is permanent magnets arranged in such a way that it allows continuous movement to produce energy.
The objective of the device where one or more of the magnets are attached to device which moves the magnet(s) to maximize the free flow of the movement created by the magnetic fields.
The objective of the device to incorporate a piston to maximize the production of energy.
The objective of the device to incorporate materials that redirect the magnetic fields to maximize the production of energy.
The objective of the device to incorporate materials that redirect the magnetic fields to maximize the production of energy.
The objective of the device to incorporate any pre-existing braking device.
The objective of the device to incorporate any pre-existing generating device.
The objective of the device to incorporate any locomotive device.
The objective of the device that incorporates any number of pistons or other devices.

### BRIEF DESCRIPTION OF SEVERAL VIEWS OF THE DRAWING

FIG. 1 is a side view of one section of power generation of the Magnaforce Generator.

FIG. 2 is an over head view of a primary function in power generation of the Magnaforce Generator.

### DETAILED DESCRIPTION OF THE INVENTION

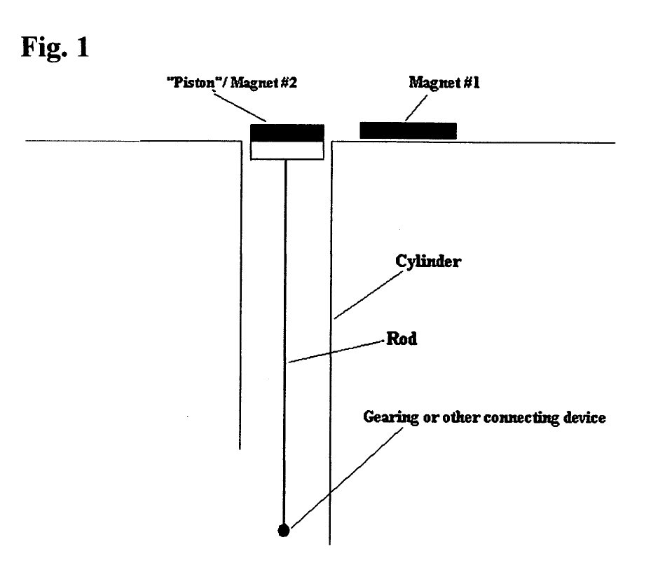

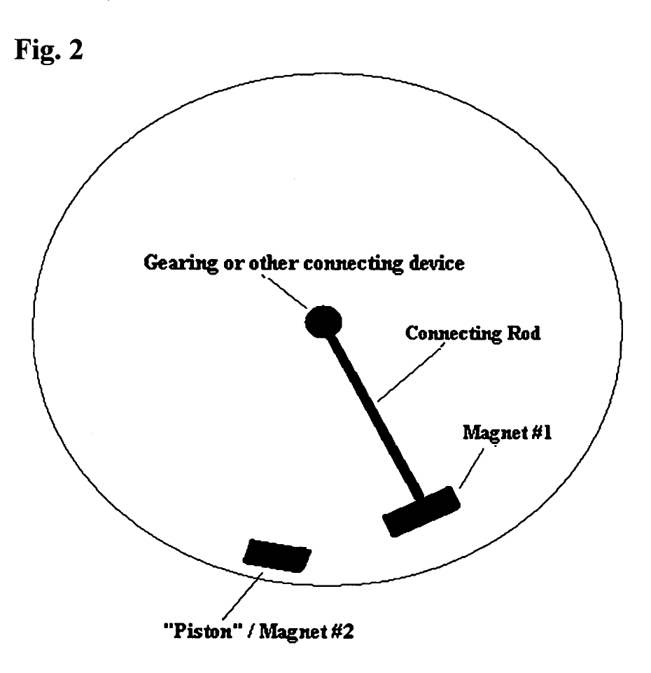

Both FIGS. 1 and 2 show one of many configurations that could be used to obtain continuous motion using permanent magnets to generate energy as described in claims 1-9. As Magnet #1 passes by Magnet #2 (see FIG. 2), Magnet #2 retreats into a cylinder via a “piston” (see FIG. 1) linked to Magnet #1 so that during the optimal time Magnet #2 would extend into the optimal position to push Magnet #1 via the two magnets' opposing and /or attracting fields. Magnet #2 would also retreat into the cylinder in order to avoid conflicting polarities and at the same time generate energy in combination with Magnet #1. The above configuration could be accomplished with many different arrangements of the same basic principal. Additionally, the cylinder could be of any shape or workable dimension as could any of the devices described in claims 1-9. FIGS. 1 and 2 are not meant to limit the claims. The figures are only meant to depict the basic principal behind the Claims.

What is claimed:

1. Permanent magnets arranged in such a way that it allows continuous movement to produce energy.

2. The device described in claim 1 where one or more of the magnets are attached to device which moves the magnet(s) to maximize the free flow of the movement created by the magnetic fields.

3. The device described in claims 1 and 2 which incorporates a piston to maximize the production of energy.

4. The device described in claims 1, 2, and 3 which incorporates materials that redirect the magnetic fields to maximize the production of energy.

5. The device described in claims 1 and 2 which incorporates materials that redirect the magnetic fields to maximize the production of energy.

6. The device described in claims 1-5 that incorporates any pre-existing braking device.

7. The device described in claims 1-5 that incorporates any pre-existing generating device.

8. The device described in claims 1-5 that incorporates any locomotive device.

9. The device described in claims 1-5 that incorporates any number of pistons or other devices described in claims 1-8.
